(19) United States
(12) Patent Application Publication
(10) Pub. No.: US 2024/0394562 A1
(43) Pub. Date: Nov. 28, 2024

(54) ESTIMATING EXECUTION METRICS OF DIFFERENT ANNEALERS FOR SLO OPTIMIZATION

(71) Applicant: Dell Products L.P., Round Rock, TX (US)

(72) Inventors: Rômulo Teixeira de Abreu Pinho, Niterói (BR); Brendan Burns Healy, Haddonfield, NJ (US); Miguel Paredes Quiñones, Campinas (BR)

(21) Appl. No.: 18/321,207

(22) Filed: May 22, 2023

(51) Int. Cl. G06N 5/022; G06N 5/04

(52) U.S. Cl. CPC G06N 5/022; G06N 5/04

(57) ABSTRACT

One example method includes receiving a QUBO (quadratic unconstrained binary optimization) job, providing the QUBO job and annealer parameters as inputs to a trained model, performing an inferencing process that comprises using the trained model to predict, based on the inputs, respective values of service level objective metrics, comparing the values of the service level objective metrics with service level objective metrics provided by a user, and based on the comparing, orchestrating the QUBO job to an annealer that is expected to be able to satisfy the service level objective metrics provided by the user.

### FIELD OF THE INVENTION

Embodiments of the present invention generally relate to orchestration of computing jobs. More particularly, at least some embodiments of the invention relate to systems, hardware, software, computer-readable media, and methods, for estimating execution metrics of quantum annealers for use as an input to an orchestrator for placement of a computing job.

### BACKGROUND

A computation infrastructure for execution of large optimization problems in a QUBO (quadratic unconstrained binary optimization) formulation may comprise several types of annealers, which may be digital, quantum, or simulated, or even classical annealing, operating side-by-side with classical high-performance computation. From an orchestration perspective, deciding where, that is, on which computing infrastructure, to run each optimization job in such a diverse infrastructure is challenging.

An orchestrator may require, in addition to knowledge about job queues and occupation of computing machines, some inferencing capabilities to predict how jobs are likely to execute on some particular computing hardware. This information may help an orchestrator decide where to place each job, while satisfying user constraints encoded in SLO (service level objective) metrics. SLO metrics for optimization jobs may comprise, for example, execution times, resource usage such as memory of an acceleration card, and the quality of the optimization solution, such as the value of the cost function or of the energy of the Hamiltonian. One significant challenge for such inferencing processes is determination of the predictors of the SLO metrics in different annealing hardware.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1a discloses aspects of an example architecture, according to one embodiment.

FIG. 1b discloses an example dataset and configuration, according to one embodiment.

FIG. 2 discloses aspects of an example method, according to one embodiment.

FIG. 3 discloses an example computing entity operable to perform any of the disclosed methods, processes, and operations.

### DETAILED DESCRIPTION OF SOME EXAMPLE EMBODIMENTS

Embodiments of the present invention generally relate to orchestration of computing jobs. More particularly, at least some embodiments of the invention relate to systems, hardware, software, computer-readable media, and methods, for estimating execution metrics of quantum annealers for use as an input to an orchestrator for placement of a computing job.

One example embodiment comprises a method and inferencing model, such as an ML (machine learning) model, or simply ‘model,’ that may operate to assist in the orchestration of computing jobs, one example of which is quantum optimization jobs. Initially, a set of annealers may be selected and, for each annealer, parameters are identified that are expected to be likely predictors of values for one or more SLO metrics. Several QUBO (quadratic unconstrained binary optimization) problems, or instances, may then be run on each annealer while the parameters are varied in a controlled manner, and the SLO metrics of interest obtained for each QUBO execution. A dataset may then be constructed that may include information about the QUBO jobs and the corresponding annealers. A prediction model may be trained for each of the annealers in the dataset. The trained model may then be deployed, such as to an orchestrator. At inference time, the orchestrator may receive a new QUBO job, and then use the trained model to identify, and select, a hardware configuration that is able to run the QUBO job while maintaining adherence to the SLO requirements.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that an orchestrator may identify which hardware configurations are, and/or are not, able to perform a particular computing job while also satisfying an applicable SLO requirement. As another example, and embodiment may predict the performance of various different annealers, with respect to one or more SLO metrics. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of An Example Architecture and Environment

The following is a discussion of aspects of example operating environments for various embodiments of the invention. This discussion is not intended to limit the scope of the invention, or the applicability of the embodiments, in any way.

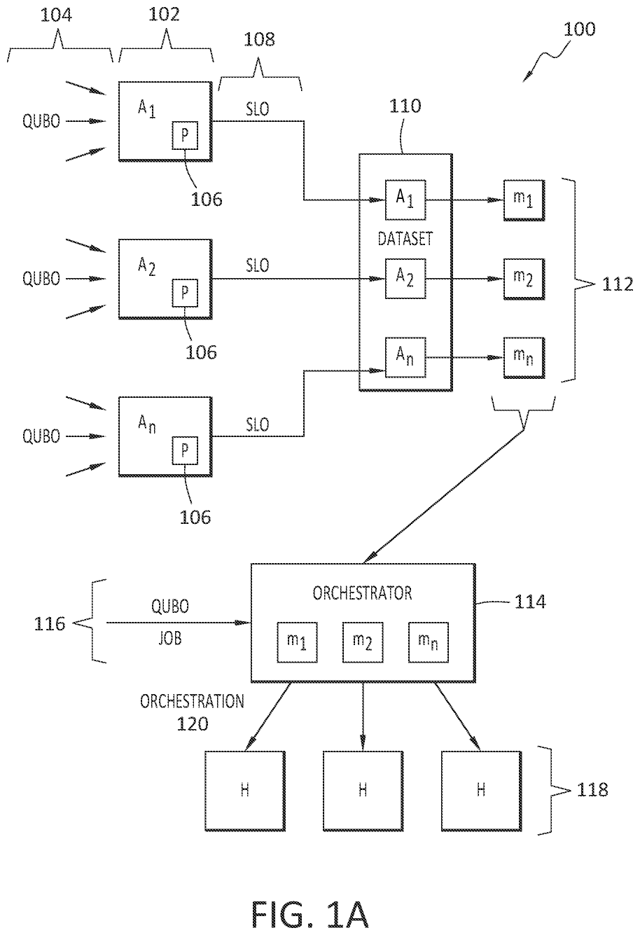

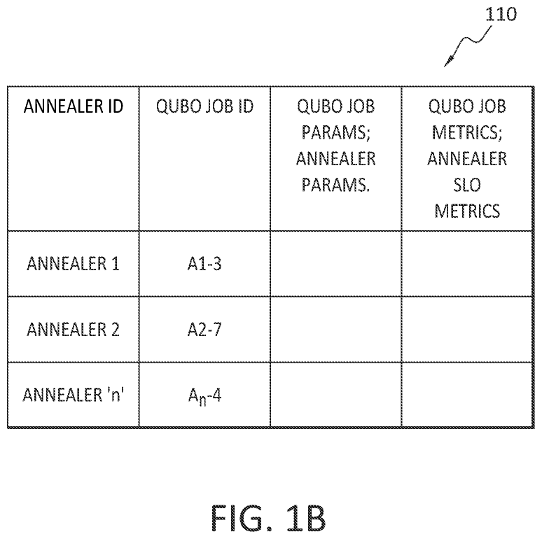

With particular attention now to FIG. 1a, one example of an architecture according to one embodiment is denoted generally at 100. In general, the architecture 100 may comprise various quantum annealers 102. Any of the quantum annealers 102 may comprise simulated hardware and/or physical hardware. The quantum annealers 102 may be configured to receive, and run, one or more QUBO jobs, or instances, 104. In an embodiment, a QUBO job 104 may comprise an optimization problem. Each of the quantum annealers 102 may execute one or more instances of the QUBO jobs 104, and one or more parameters in a set of QUBO execution parameters 106, or simply ‘parameters,’ may be varied for each execution of a QUBO instance. Some example parameters 106 may include, but are not limited to, number of reads (times that the QUBO instance is performed for a set of parameters), number of sweeps (number of annealing steps), and inverse temperature or beta (the inverse of temperature with the Boltzmann constant set to 1 (β=1/T)). The parameters may be selected based on the extent to which they are known, or expected, to be predictive of one or more SLO metrics.

For each QUBO execution, respective values of various SLO metrics 108 of interest may be obtained. In an embodiment, SLO metrics 108 for optimization jobs may comprise, for example, execution times, resource usage such as memory of an acceleration card, and the quality of the optimization solution, for example, the value of a cost function or of the energy of Hamiltonian. Information and data such as, but not limited to, SLO metrics 108, annealer 102 ID, QUBO job 104 ID, QUBO job 104 parameters and annealer 102 parameters, and QUBO job 104 metrics and annealer 102 SLO 108 metrics, may be stored in a dataset 110.

For each of the annealers 102 in the dataset 110, a respective prediction model 112 may be trained. In an embodiment, each of the prediction model 112 is operable to predict one or more SLO metrics, given some input. Such input may comprise, but is not limited to, information and data contained in the dataset 110. The various prediction models 112 may be deployed to an orchestrator 114. When the orchestrator 114 receives a new QUBO job 116, the orchestrator 114 may then select the prediction model 112 whose output indicates that a corresponding annealer 102 is able to perform the QUBO job 116, while maintaining compliance with the SLO requirements. In FIG. 1a, each of the various hardware configurations 118 may comprise a different respective annealer, such as one of the annealers 102. In an embodiment, the output of a prediction model 112 may identify a particular hardware configuration 118, and a hardware configuration 118 may comprise quantum computing hardware and/or classical computing hardware. The orchestrator 114 may then orchestrate 120 the QUBO job 116 to a suitable, or the most suitable, hardware configuration 118.

With reference briefly to FIG. 1b, an example dataset 110 is disclosed. As shown in this example, each row of the dataset 110 may comprise the following fields: annealer ID; QUBO job ID; QUBO job and annealer parameters; and, QUBO job and annealer SLO metrics. The dataset 110 in FIG. 1b is provided only by way of example and is not intended to limit the scope of the invention in any way. Datasets of other configurations, and content, may alternatively be employed.

### B. Example Methods

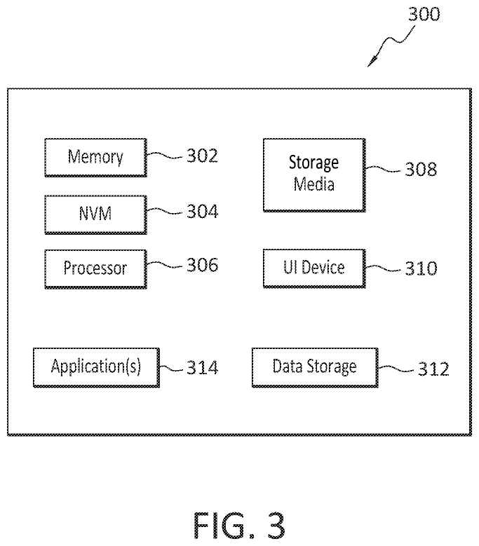

It is noted with respect to the disclosed methods, including the example method of FIG. 3 that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited. With the discussion of FIGS. 1a and 1b, following is a discussion of aspects of methods according to one or more embodiments of the invention.

In an embodiment, the most relevant predictors of SLO metrics for different annealers may be identified. These predictors may be of various types. To illustrate, for an annealer of type 1, an embodiment may identify the number of variables, and the density of, a QUBO matrix. The size and density of a QUBO matrix may be features of the submitted problem, that is, of the QUBO. Predictors may be of other types as well. To illustrate, for an annealer of type 2, an embodiment may additionally identify the inverse temperature (beta) to arrive at a better solution at each iteration than another predictor. In contrast with the QUBO size and density, which are problem features, the beta, or beta range, is an example of a hyperparameter whose value(s) may be controlled by a user.

In light of the foregoing considerations, a method according to one example embodiment may proceed as follows:
1. for each annealer, identify the SLO metrics that are to be predicted-such as, for example, QUBO job execution time, and cost to perform the QUBO job—and obtain a set of QUBO job execution parameters that are likely to be predictors of such SLO metrics, where such predictors may include, for example, number of sweeps, number of reads, and beta (inverse temperature);
2. execute several QUBO instances on each annealer, while varying the identified set of parameters in a controlled fashion for each QUBO instance execution—in an embodiment, a QUBO problem may be obtained randomly, and other QUBO problems obtained from basic problems with known solution, for example;
3. for each execution of a QUBO instance, obtain the SLO metrics of interest;
4. build a dataset, such as the dataset 110;
5. for each annealer in the dataset, train a prediction model y=f (x|θ), with all {x,y} pairs associated with that annealer, where x represents the QUBO and annealer parameters, y represents the SLO metrics, and θ represents the parameters of the prediction model f;
6. deploy the trained model(s) to an orchestrator, as part of an orchestration solution to decide the best hardware to run the QUBO jobs;
7. at inference time, the orchestrator receives a new QUBO job into its job queue, along with SLO metrics to be satisfied, such as, for example, execution time <500s and quality >10—in an embodiment, the SLO metrics may be specified by a user—then obtain the parameters of the QUBO job and identify, also by the orchestrator, which annealers, if any, support that set of QUBO job parameters—for example, the parameters may comprise [1] number of variables (that is, QUBO size), [2] QUBO matrix density, and [3] number of sweeps—in this example, and given some QUBO size and matrix density, adjusting a beta range on annealer type 1 may be most helpful in generating accurate predictions, while, for that same QUBO size and matrix density, adjusting a sweeps value on annealer 2 may be more helpful in generating accurate predictions;
8. invoke, by the orchestrator, the trained prediction models of the valid annealers and run those prediction models in inference mode using, as inputs to the prediction models, the [1] QUBO parameters and [2] annealer parameters;
9. obtain, by the orchestrator, predictions of SLO metrics from each model, and compares those predictions with the SLO metrics provided by the user; and
10 filter out, by the orchestrator, any annealers that are unlikely to satisfy the given SLO metrics and put the job into a queue for hardware that is able to support the job-such as a queue that is least full as among multiple queues—in an embodiment, this may be measured as follows: whenever an execution time is predicted for a given job/hardware combination, that execution time is stored in a list of queued jobs for the hardware selected, then, the sum of the execution times may act as a self-updating “time to front of line” metric for each hardware, assuming when a job is completed, its respective predicted time is cleared.

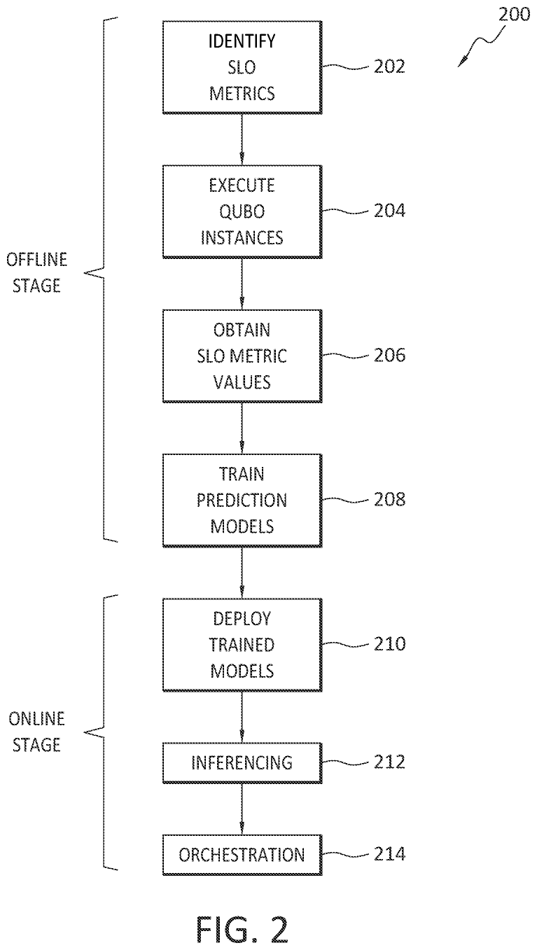

With attention now to FIG. 2, a method according to one example embodiment is generally denoted at 200. In an embodiment, part, or all, of the method 200 may be performed by an orchestrator. Further, in an embodiment, part of the method 200 may comprise a training, or offline, stage, and another part of the method may comprise an inferencing, or online, stage.

The method 200 may begin with the identification 202 of SLO metrics, such as QUBO job execution time and cost, for example, for which predictions are desired to be obtained. As part of 202, or separately, a set of annealer parameters relating to QUBO job execution are identified that are known, or expected, to be predictors of the identified SLO metrics.

After the SLO metrics, and predictive parameters, have been identified 202, QUBO instances may be run 204 on each of the annealers under consideration. In an embodiment, information about these annealers, and other information, may be included in a dataset. As a result of execution of the QUBO instances 204, respective values may be obtained 206 for the SLO metrics, for each annealer, that were identified earlier 202.

Information about the QUBOs, annealer parameters, SLO metrics, and model parameters may be used to train 208 a prediction model for each of the annealers under consideration. In an embodiment, completion of the training 208 may constitute the end of a training, or offline, stage.

In an embodiment, an inferencing, or online, stage may begin with deployment 210 of the trained prediction models, such as to an orchestrator for example. When the orchestrator receives a new QUBO job, the orchestrator may run the trained prediction models, using the new QUBO job and annealer parameters as inputs, in an inferencing 212 operation, or operations, to obtain predicted values for the selected 202 SLO metrics. The orchestrator may then orchestrate 214 the new QUBO job to an annealer, or annealers, for which the predicted values for the SLO metrics meet the requirements of the SLO.

### C. Further Discussion

As apparent from this disclosure, example embodiments may possess various useful features and aspects. For example, an embodiment may comprise a prediction mechanism configured and operable to estimate SLO metrics of different quantum annealers, any of which may comprise simulated hardware and/or real hardware, in a QUBO orchestration setting. As another example, an embodiment may perform integration of a prediction mechanism, such as for SLO metrics values, into orchestration decisions as to where to place a given QUBO job on a heterogenous annealing infrastructure in such a way to satisfy user defined SLO constraints. As a final example, an embodiment may comprise a step in an orchestration decision process to identify valid annealers for a given QUBO configuration.

### D. Further Example Embodiments

Following are some further example embodiments of the invention. These are presented only by way of example and are not intended to limit the scope of the invention in any way.

Embodiment 1. A method, comprising: receiving a QUBO (quadratic unconstrained binary optimization) job; providing the QUBO job and annealer parameters as inputs to a trained machine learning model; performing an inferencing process that comprises using the trained machine learning model to predict, based on the inputs, respective values of service level objective metrics; comparing the values of the service level objective metrics with service level objective metrics provided by a user; and based on the comparing, orchestrating the QUBO job to an annealer that is expected to be able to satisfy the service level objective metrics provided by the user.

Embodiment 2. The method as recited in any preceding embodiment, wherein the QUBO is received by an orchestrator to which the trained machine learning model was deployed.

Embodiment 3. The method as recited in any preceding embodiment, wherein the service level objective metrics provided by the user comprise execution metrics for the QUBO job.

Embodiment 4. The method as recited in any preceding embodiment, wherein the inferencing process is performed for each annealer in a group of annealers, and the group of annealers includes the annealer to which the QUBO job is orchestrated.

Embodiment 5. The method as recited in any preceding embodiment, wherein the annealer is one of a group of annealers, and one or more annealers in the group of annealers comprises real hardware and/or simulated hardware.

Embodiment 6. The method as recited in any preceding embodiment, wherein the annealer parameters comprise any one of more of a beta range, number of sweeps, number of reads, and/or job parameters provided to the trained machine learning model comprise one or both of QUBO matrix size and QUBO matrix density.

Embodiment 7. The method as recited in any preceding embodiment, wherein the orchestrating comprises filtering out one or more annealers that are not expected to be able to satisfy the service level objective metrics provided by the user.

Embodiment 8. The method as recited in any preceding embodiment, wherein receiving the QUBO job comprises receiving parameters of the QUBO job, and identities of one or more annealers that support the parameters of the QUBO job, and the annealer to which the QUBO job is orchestrated is included in the one or more annealers.

Embodiment 9. The method as recited in any preceding embodiment, wherein the annealer to which the QUBO job is orchestrated is included in a group of annealers, and the group of annealers collectively defines a heterogeneous annealing infrastructure.

Embodiment 10. The method as recited in any preceding embodiment, wherein the annealer parameters are selected as inputs to the trained machine learning model based on an extent to which they are expected to be able to be used to predict a value of a service level objective metric.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. In an embodiment, a computer and computing system may comprise quantum computing hardware, classical computing hardware, or a combination of the two. Quantum computing hardware may comprise, but is not limited to, annealers. Other annealers may comprise classical computing hardware and/or quantum computing hardware.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

With reference briefly now to FIG. 3, any one or more of the entities disclosed, or implied, by FIGS. 1a-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a QUBO (quadratic unconstrained binary optimization) job;
providing the QUBO job and annealer parameters as inputs to a trained machine learning model;
performing an inferencing process that comprises using the trained machine learning model to predict, based on the inputs, respective values of service level objective metrics;
comparing the values of the service level objective metrics with service level objective metrics provided by a user; and
based on the comparing, orchestrating the QUBO job to an annealer that is expected to be able to satisfy the service level objective metrics provided by the user.

2. The method as recited in claim 1, wherein the QUBO is received by an orchestrator to which the trained machine learning model was deployed.

3. The method as recited in claim 1, wherein the service level objective metrics provided by the user comprise execution metrics for the QUBO job.

4. The method as recited in claim 1, wherein the inferencing process is performed for each annealer in a group of annealers, and the group of annealers includes the annealer to which the QUBO job is orchestrated.

5. The method as recited in claim 1, wherein the annealer is one of a group of annealers, and one or more annealers in the group of annealers comprises real hardware and/or simulated hardware.

6. The method as recited in claim 1, wherein the annealer parameters comprise any one of more of a beta range, number of sweeps, number of reads, and/or job parameters provided to the trained machine learning model comprise one or both of QUBO matrix size and QUBO matrix density.

7. The method as recited in claim 1, wherein the orchestrating comprises filtering out one or more annealers that are not expected to be able to satisfy the service level objective metrics provided by the user.

8. The method as recited in claim 1, wherein receiving the QUBO job comprises receiving parameters of the QUBO job, and identities of one or more annealers that support the parameters of the QUBO job, and the annealer to which the QUBO job is orchestrated is included in the one or more annealers.

9. The method as recited in claim 1, wherein the annealer to which the QUBO job is orchestrated is included in a group of annealers, and the group of annealers collectively defines a heterogeneous annealing infrastructure.

10. The method as recited in claim 1, wherein the annealer parameters are selected as inputs to the trained machine learning model based on an extent to which they are expected to be able to be used to predict a value of a service level objective metric.

11. A non-transitory storage medium having stored therein instructions that are executable by one or more hardware processors to perform operations comprising:
receiving a QUBO (quadratic unconstrained binary optimization) job;
providing the QUBO job and annealer parameters as inputs to a trained machine learning model;
performing an inferencing process that comprises using the trained machine learning model to predict, based on the inputs, respective values of service level objective metrics;
comparing the values of the service level objective metrics with service level objective metrics provided by a user; and
based on the comparing, orchestrating the QUBO job to an annealer that is expected to be able to satisfy the service level objective metrics provided by the user.

12. The non-transitory storage medium as recited in claim 11, wherein the QUBO is received by an orchestrator to which the trained machine learning model was deployed.

13. The non-transitory storage medium as recited in claim 11, wherein the service level objective metrics provided by the user comprise execution metrics for the QUBO job.

14. The non-transitory storage medium as recited in claim 11, wherein the inferencing process is performed for each annealer in a group of annealers, and the group of annealers includes the annealer to which the QUBO job is orchestrated.

15. The non-transitory storage medium as recited in claim 11, wherein the annealer is one of a group of annealers, and one or more annealers in the group of annealers comprises real hardware and/or simulated hardware.

16. The non-transitory storage medium as recited in claim 11, wherein the inferencing process is performed for each annealer in a group of annealers, and the group of annealers includes the annealer to which the QUBO job is orchestrated.

17. The non-transitory storage medium as recited in claim 11, wherein the orchestrating comprises filtering out one or more annealers that are not expected to be able to satisfy the service level objective metrics provided by the user.

18. The non-transitory storage medium as recited in claim 11, wherein receiving the QUBO job comprises receiving parameters of the QUBO job, and identities of one or more annealers that support the parameters of the QUBO job, and the annealer to which the QUBO job is orchestrated is included in the one or more annealers.

19. The non-transitory storage medium as recited in claim 11, wherein the annealer to which the QUBO job is orchestrated is included in a group of annealers, and the group of annealers collectively defines a heterogeneous annealing infrastructure.

20. The non-transitory storage medium as recited in claim 11, wherein the annealer parameters are selected as inputs to the trained machine learning model based on an extent to which they are expected to be able to be used to predict a value of a service level objective metric.
